(19) United States
(12) Patent Application Publication
(10) Pub. No.: US 2025/0047375 A1
(43) Pub. Date: Feb. 6, 2025

(54) OPTIMIZING TRANSMISSION OPPORTUNITY (TXOP) USAGE IN COORDINATED-TIME DIVISION MULTIPLE ACCESS (C-TDMA) TRANSMISSION FOR ENHANCED SYSTEM THROUGHPUT

(71) Applicant: NEWRACOM, Inc., Irvine, CA (US)

(72) Inventors: Si-Chan NOH, Seoul (KR); Joonsoo LEE, Seoul (KR)

(73) Assignee: NEWRACOM, Inc., Irvine, CA (US)

(21) Appl. No.: 18/785,495

(22) Filed: Jul. 26, 2024

Related U.S. Application Data
(60) Provisional application No. 63/517,492, filed on Aug. 3, 2023.
(60) Provisional application No. 63/579,274, filed on Aug. 28, 2023.

(51) Int. Cl. H04B 7/26

(52) U.S. Cl. CPC H04B 7/2612; H04B 7/2656

(57) ABSTRACT

Dynamic Transmission Opportunity (TXOP) sharing between overlapping Basic Service Sets (BSSs) in wireless networks. A sharing Access Point (AP) initiates a process by generating and wirelessly transmitting a control frame to allocate its TXOP to a shared AP in an overlapping BSS. Subsequently, the sharing AP receives a return TXOP frame from the shared AP, indicating the return of any unused TXOP portion. The sharing AP then has the flexibility to either resume its own transmissions using the returned TXOP or reallocate it to an alternative AP. Using the techniques in dense wireless networking environments enables efficient spectrum utilization through dynamic TXOP allocation and reclamation. The techniques address challenges of resource management in multi-AP scenarios, improving overall network performance and reducing interference in overlapping coverage areas.

### CROSS-REFERENCE TO RELATED APPLICATIONS

This application claims the benefit of U.S. Provisional Application Nos. 63/517,492 filed Aug. 3, 2023 and 63/579,274 filed Aug. 28, 2023, the entire contents of each of which are hereby incorporated by reference.

### TECHNICAL FIELD

The present disclosure generally relates to wireless communications, and more specifically, relates to optimizing transmission opportunity (TXOP) usage in coordinated-time division multiple access (C-TDMA) transmission for enhanced system throughput in Wi-Fi standards beyond the next-generation such as beyond Institute of Electrical and Electronics Engineers (IEEE) 802.11be.

### BACKGROUND

Institute of Electrical and Electronics Engineers (IEEE) 802.11 is a set of standards for implementing wireless local area network (WLAN) communication in various frequencies, including but not limited to the 2.4 gigahertz (GHz), 5 GHZ, 6 GHZ, and 60 GHz bands. These standards define the protocols that enable Wi-Fi devices to communicate with each other. The 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for WLANs. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming. The IEEE 802.11be standard is projected to be finalized by the end of 2024, paving the way for the next generation of Wi-Fi devices and networks.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a carrier sense multiple access with collision avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in extremely high throughput physical layer protocol data unit (EHT PPDU) frames, including their purposes and characteristics, in accordance with some embodiments of the present disclosure.

FIG. 8 illustrates an example of multi-user orthogonal frequency division multiple access (MU-OFDMA) transmission where multiple frames are transmitted to or from multiple stations (STAs) simultaneously using different frequency resources, in accordance with some embodiments of the present disclosure.

FIG. 9 illustrates an example of an access point sending a trigger frame to multiple associated STAs and receiving uplink orthogonal frequency division multiple access trigger-based physical layer protocol data units (UL OFDMA TB PPDUs) in response, in accordance with some embodiments of the present disclosure.

FIG. 10 illustrates an example transmission opportunity (TXOP) sharing frame sequence in coordinated time division multiple access (C-TDMA), in accordance with some embodiments of the present disclosure.

FIG. 11 illustrates an example of returning a remaining TXOP from a shared access point (shared AP) to a sharing access point (sharing AP), in accordance with some embodiments of the present disclosure.

FIG. 12 illustrates an example wireless network topology when a third-party station (third-party STA) can overhear physical layer protocol data units (PPDUs) between a sharing access point (AP) and a shared AP, in accordance with some embodiments of the present disclosure.

FIG. 13 illustrates an example wireless network topology when a third-party STA can overhear PPDUs of a shared AP but cannot overhear PPDUs of a sharing AP, in accordance with some embodiments of the present disclosure.

FIG. 14 illustrates an example signaling design of a return TXOP sequence while considering the third-party STA in the network topology of FIG. 12, in accordance with some embodiments of the present disclosure.

FIG. 15 illustrates an example signaling design of a return TXOP sequence while considering the third-party STA in the network topology of FIG. 13, in accordance with some embodiments of the present disclosure.

FIG. 16 illustrates an example of a modified control frame as a return TXOP frame, in accordance with some embodiments of the present disclosure.

FIG. 17 illustrates an example method performed by a wireless device operating as a sharing access point in wireless network for optimizing TXOP usage in C-TDMA transmission for enhanced system throughput beyond IEEE 802.11be, according to some embodiments of the present disclosure.

FIG. 18 illustrates an example method performed by a wireless device operating as a shared access point in wireless network for optimizing TXOP usage in C-TDMA transmission for enhanced system throughput beyond IEEE 802.11be, according to some embodiments of the present disclosure.

### DETAILED DESCRIPTION

The present disclosure generally relates to wireless communications, and more specifically, relates to optimizing transmission opportunity (TXOP) usage in coordinated-time division multiple access (C-TDMA) transmission for enhanced system throughput beyond Institute of Electrical and Electronics Engineers (IEEE) 802.11be.

### Overview

In the development of Wi-Fi standards beyond IEEE 802.11be, multiple multi-access point (multi-AP) schemes are being considered to enhance spectral efficiency in high-density network environments. These schemes include C-TDMA, coordinated-orthogonal frequency division multiple access (C-OFDMA), coordinated-beamforming (C-BF), coordinated-nulling, and joint transmission (JTX). Particular attention is being given to C-TDMA transmissions, where an efficient method for returning unused TXOPs from shared access points (shared APs) to sharing access points (sharing APs) may be needed. The current IEEE 802.11 standard lacks an optimal mechanism for this process, especially one that accounts for the presence and operation of third-party stations (third-party STAs).

To address this deficiency and improve resource utilization, a novel mechanism is disclosed herein. This mechanism is centered on the signaling design of control frames and is engineered to facilitate the return of both full and remaining TXOPs while the potential impact on third-party STAs is taken into consideration. The disclosed approach is designed to enable sharing APs to receive returned TXOPs from shared APs without collisions being incurred and to minimize adverse effects on third-party STAs. Through the implementation of the disclosed mechanism, the overall efficiency of resource utilization in C-TDMA transmissions may be significantly enhanced, thereby contributing to improved system throughput in next-generation Wi-Fi networks.

The disclosed mechanism supports the C-TDMA scheme in Wi-Fi standards beyond IEEE 802.11be. The disclosed mechanism is designed to enable a shared AP to return either the full or remaining TXOP to a sharing AP. With the disclosed mechanism, the TXOP return process is engineered to occur without collisions and to mitigate harmful effects on third-party STAs. Upon receipt of the returned TXOP, efficient resumption of frame exchanges by the sharing AP is facilitated.

The disclosed approach encompasses a methodology by which third-party STAs are handled when the TXOP return process is overheard. The methodology encompasses a technique for the interpretation of frames indicating TXOP returning by third-party STAs, as well as a protocol for managing their behavior when a returned TXOP is overheard. These features are specifically designed to enhance both medium access efficiency and operational flexibility within the network. Through the disclosed approach, the utilization of wireless resources in high-density network scenarios and the overall performance of Wi-Fi systems employing C-TDMA is improved.

In an embodiment, a first method is performed by a wireless device functioning as a sharing access point (AP) in a first basic service set (BSS) for dynamic transmission opportunity (TXOP) sharing and reclamation in overlapping wireless networks. The sharing AP initiates the process by generating a control frame designed to allocate its TXOP to a shared AP located in a second, overlapping BSS. This control frame is then wirelessly transmitted to facilitate the TXOP allocation. Subsequently, the sharing AP receives a return TXOP frame from the shared AP, indicating that a portion of the originally allocated TXOP remains unused and is being returned. Upon receiving this frame, the sharing AP has two options for utilizing the returned TXOP: it can either resume its own wireless data transmission using the buffered data at the sharing AP, or it can reallocate a portion of the returned TXOP to an alternative AP.

This method first exemplifies advanced coordination techniques in dense wireless networking environments, allowing for more efficient use of channel resources by enabling dynamic TXOP sharing and reclamation between overlapping BSSs. It addresses the challenges of spectrum efficiency and network coordination in scenarios where multiple APs operate in proximity, potentially improving overall network performance and reducing interference.

In an embodiment, a wireless device capable of functioning as a sharing access point in a first basic service comprises a radio frequency transceiver, a memory device, a set of one or more processors coupled to the memory device; and a set of instructions stored in the memory and configured to cause the sharing access point to perform the first method.

In an embodiment, a second method is executed by a wireless device functioning as a shared access point (AP) in a first basic service set (BSS), delineates a process for receiving, utilizing, and returning a transmission opportunity (TXOP) in overlapping wireless networks. The shared AP initially receives a control frame wirelessly transmitted by a sharing AP located in a second, overlapping BSS. This control frame is designed to facilitate the allocation of a TXOP from the sharing AP to the shared AP. Upon receiving the allocated TXOP, the shared AP has two options for its utilization: it can either wirelessly transmit its own physical layer protocol data unit (PPDU) during the TXOP, or it can solicit a wireless PPDU transmission from a station within its BSS. After utilizing a portion of the allocated TXOP, the shared AP generates a return TXOP frame. This frame is crafted to facilitate the return of any unused portion of the TXOP to the original sharing AP. Finally, the shared AP wirelessly transmits this return TXOP frame, effectively returning the remaining portion of the TXOP to the sharing AP.

This second method exemplifies sophisticated coordination techniques in dense wireless network deployments, enabling efficient use of channel resources through dynamic TXOP sharing and reclamation between overlapping BSSs. It addresses challenges related to spectrum efficiency and network coordination in scenarios with multiple proximate APs, potentially enhancing overall network performance and mitigating interference.

In an embodiment, a wireless device capable of functioning as a sharing access point in a first basic service comprises a radio frequency transceiver, a memory device, a set of one or more processors coupled to the memory device; and a set of instructions stored in the memory and configured to cause the sharing access point to perform the second method.

Embodiments also encompass a wireless device comprising a radio frequency transceiver, a memory device, a set of one or more processors coupled to the memory device, and a set of instructions stored in the memory device and configured to cause the wireless device to perform any of the foregoing methods.

### Wireless Communications

In this detailed description, only certain embodiments are shown and described, simply by way of illustration. As those skilled in the art would realize, the described embodiments may be modified in various ways, all without departing from the spirit or scope of the present disclosure. Accordingly, the drawings and description are to be regarded as illustrative in nature and not restrictive. Like reference numerals designate like elements throughout the specification.

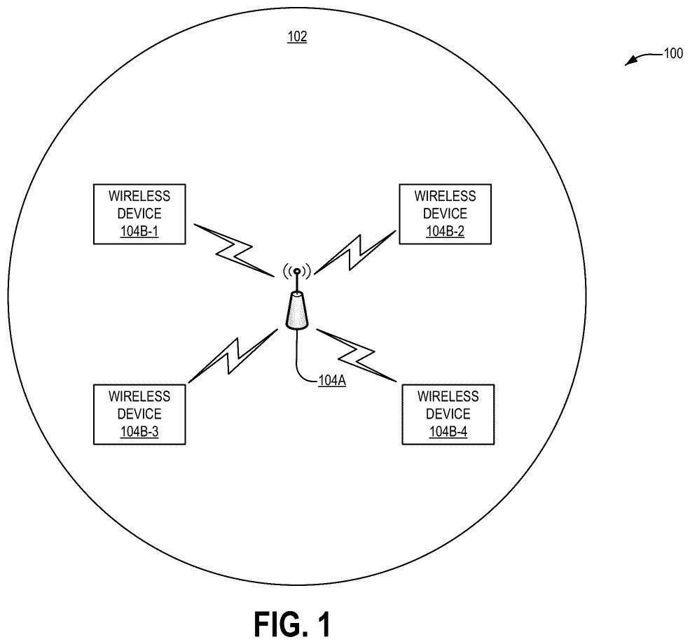

Turning now to FIG. 1, it illustrates example wireless local area network (WLAN) 100. WLAN 100 encompasses example basic service set (BSS) 102. BSS 102 may be composed of multiple WLAN devices 104. Each WLAN device 104 within BSS 102 may be equipped with a medium access control (MAC) layer and a physical layer (PHY), which adhere to one or more IEEE 802.11 standards.

Among WLAN devices 104 in BSS 102, at least one device serves as an access point station (AP STA) 104A, while the remaining devices function as non-AP stations (non-AP STAs) 104B. In an ad-hoc networking environment, all WLAN devices 104 may be non-AP STAs. Generally, both the AP STAs and the non-AP STAs can be referred to individually as a station (STA) or collectively as stations (STAs). However, for the sake of providing clear examples in this description, only the non-AP STAs are referred to as STAs.

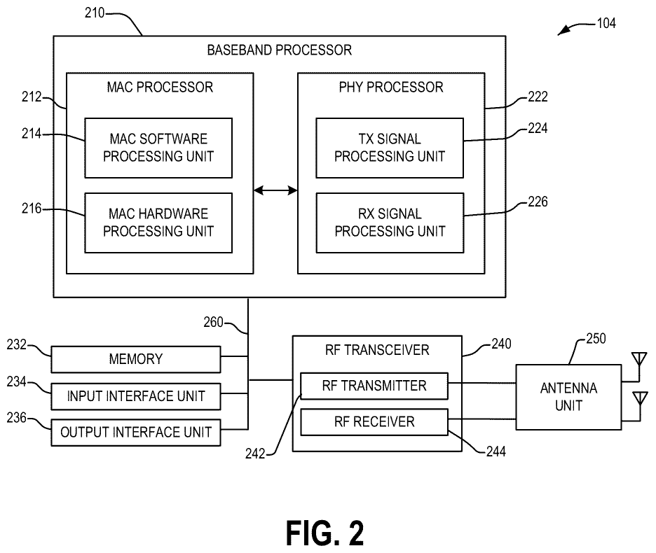

FIG. 2 is a schematic block diagram that represents a WLAN device, labeled as WLAN device 104, which comprises several components. Baseband processor 210 may be responsible for performing baseband signal processing and includes two sub-components: MAC processor 212 and PHY processor 222. MAC processor 212 may be further divided into MAC software processing unit 214 and MAC hardware processing unit 216. Memory 232, which can be a non-transitory computer-readable medium, stores MAC software that implements some functions of the MAC layer. MAC software processing unit 214 executes this software, while MAC hardware processing unit 216 implements the remaining MAC layer functions in hardware.

PHY processor 222 comprises transmitting (TX) signal processing unit 224 and receiving (RX) signal processing unit 226, which handle the PHY processing of the transmitted and received signals, respectively.

Other components of WLAN device 104 include RF transceiver 240, which facilitates wireless communication, antenna unit 250 for transmitting and receiving signals, input interface unit 234 for receiving user input, and output interface unit 236 for providing output to the user. All these components, along with baseband processor 210 and memory 232, communicate with each other through bus 260, which serves as a communication pathway within the device.

RF transceiver 240 may be a component of WLAN device 104 that encompasses two sub-components: RF transmitter 242 and RF receiver 244. These sub-components are responsible for transmitting and receiving RF signals, respectively.

In addition to storing the MAC software, memory 232 may also store an operating system and various applications necessary for the functioning of the WLAN device.

Input interface unit 234 may be responsible for receiving information from the user, such as commands or data input. On the other hand, output interface unit 236 may be tasked with outputting information to the user, which could include status updates, processed data, or any other relevant information.

Antenna unit 250 comprises one or more antennas that facilitate wireless communication between the WLAN device and other devices in the network. In cases where a multiple-input multiple-output (MIMO) or a multiuser multiple-input multiple-output (MU-MIMO) system may be employed, antenna unit 250 may include multiple antennas to support these advanced communication techniques, which enhance the capacity and performance of the wireless network.

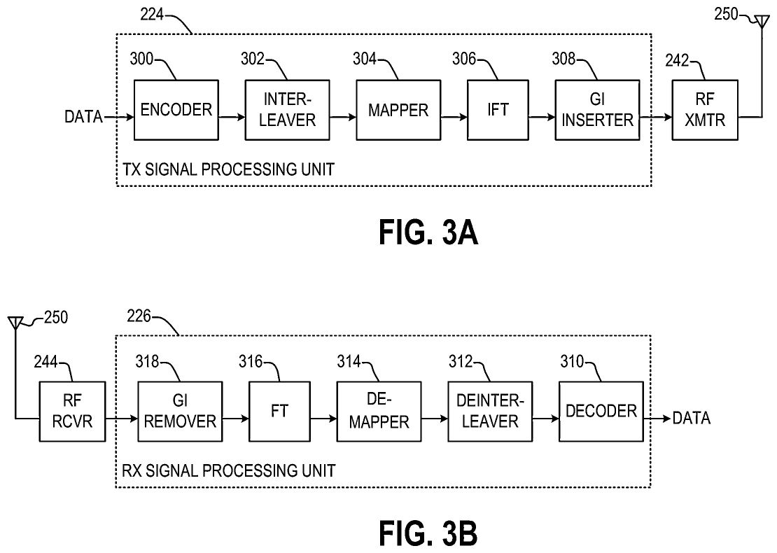

FIG. 3A illustrates transmitting signal processing unit 224 in WLAN device 104. Unit 224 encompasses several components that process the input data before transmission. Encoder 300 encodes the input data using forward error correction (FEC) techniques, such as binary convolutional code (BCC) or low-density parity-check (LDPC) encoding. A scrambler may be used to scramble the input data before encoding to reduce the occurrence of long sequences of 0s or 1s. If BCC encoding is used, an encoder parser may be employed to demultiplex the scrambled bits among multiple BCC encoders.

Interleaver 302 changes the order of bits in each stream output from the encoder, which may be applicable only when BCC encoding is used. Mapper 304 then maps the interleaved bits to constellation points. If LDPC encoding is used, mapper 304 may also perform LDPC tone mapping.

When MIMO or MU-MIMO is used, multiple interleavers 302 and mappers 304 may be employed, corresponding to the number of spatial streams (NSS). A stream parser divides the outputs of the BCC encoders or the LDPC encoder into blocks sent to different interleavers 302 or mappers 304. A space-time block code (STBC) encoder spreads the constellation points from the spatial streams into space-time streams, and a spatial mapper maps the space-time streams to transmit chains using direct mapping, spatial expansion, or beamforming.

Inverse Fourier transformer (IFT) 306 converts the constellation points from the mapper or spatial mapper to a time-domain symbol using an inverse discrete Fourier transform (IDFT) or an inverse fast Fourier transform (IFFT). When MIMO or MU-MIMO is used, cyclic shift diversities (CSDs) may be inserted to prevent unintentional beamforming, either before or after the IFT, per transmit chain, per space-time stream, or as part of the spatial mapper.

Guard interval (GI) inserter 308 prepends a GI to each symbol, and optional windowing may be applied to smooth the symbol edges. Finally, RF transmitter 242 converts the symbols into an RF signal and transmits it via antenna unit 250. In MIMO or MU-MIMO systems, the GI inserter and RF transmitter may be provided for each transmit chain.

As illustrated in FIG. 3B, receiving signal processing unit 226 in WLAN device 104 encompasses several components that process the received RF signal. RF receiver 244 receives the RF signal via antenna unit 250 and converts it into one or more symbols. GI remover 318 removes the GI from the symbol. In MIMO or MU-MIMO systems, RF receiver 244 and GI remover 318 may be provided for each receive chain.

Fourier transformer (FT) 316 converts the time-domain symbol into a block of constellation points using a discrete Fourier transform (DFT) or a fast Fourier transform (FFT). In MIMO or MU-MIMO systems, a spatial demapper may be used to convert the Fourier transformed receiver chains to constellation points of the space-time streams, and an STBC decoder may despread the constellation points from the space-time streams into the spatial streams.

Demapper 314 demaps the constellation points from FT 316 or STBC decoder to bit streams. If LDPC encoding is used, the demapper may also perform LDPC tone demapping before constellation demapping. Deinterleaver 312 deinterleaves the bits of each stream from the demapper, which may be applicable only when BCC encoding is used.

In MIMO or MU-MIMO systems, multiple demappers 314 and deinterleavers 312 may be used, corresponding to the number of spatial streams. A stream deparser may be employed to combine the streams from the deinterleavers.

Decoder 310 decodes the streams from deinterleaver 312 or stream deparser. The decoder may be an FEC decoder, such as a BCC decoder or an LDPC decoder. A descrambler may be used to descramble the decoded data. If BCC decoding is used, an encoder deparser may multiplex the data decoded by multiple BCC decoders. If LDPC decoding is used, the encoder deparser may not be necessary.

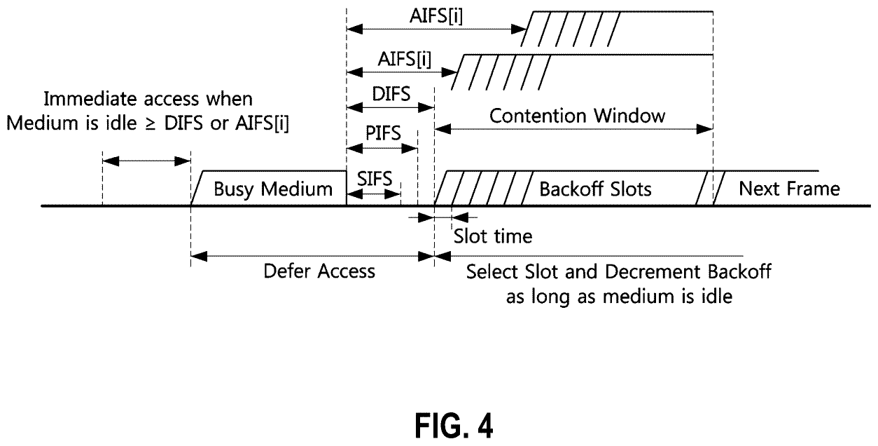

FIG. 4 illustrates the relationships between different types of interframe spaces (IFSs) in a WLAN system. WLAN devices can exchange data frames, control frames, or management frames. Data frames are used to transmit data to higher layers, and a WLAN device transmits a data frame after performing backoff if a distributed coordination function interframe space (DIFS) has elapsed from the time the medium has been idle.

Management frames are used to exchange management information that is not forwarded to higher layers. Subtype frames of management frames include beacon frames, association request/response frames, probe request/response frames, and authentication request/response frames. Control frames are used to control access to the medium and include subtypes such as request-to-send (RTS) frames, clear-to-send (CTS) frames, and acknowledgement (ACK) frames.

If a control frame is not a response frame to a previous frame, the WLAN device transmits the control frame after performing backoff if the DIFS has elapsed. However, if the control frame is a response frame to a previous frame, the WLAN device transmits the control frame without performing backoff if a short interframe space (SIFS) has elapsed. The type and subtype of a frame can be identified by the type field and subtype field in the frame control field.

Quality of Service stations (QOS STAs) may transmit frames after performing backoff if an arbitration interframe space (AIFS) for an associated access category (AC) (e.g., AIFS [AC]) has elapsed. In this case, data frames, management frames, or control frames that are not response frames may use the AIFS [AC].

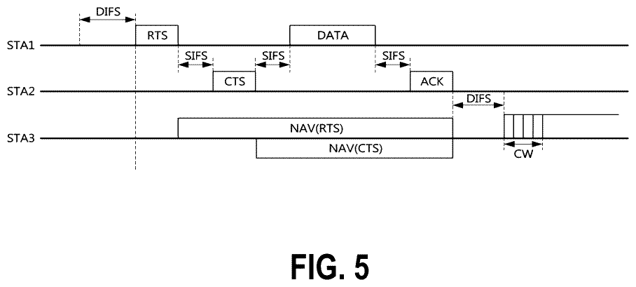

FIG. 5 illustrates a carrier sense multiple access with collision avoidance (CSMA/CA)-based frame transmission procedure for avoiding collisions between frames in a channel. In this scenario, STA1 may be the transmit WLAN device, STA2 may be the receive WLAN device, and STA3 may be a WLAN device located in an area where it can receive frames transmitted from both STA1 and STA2.

STA1 determines channel availability by carrier sensing, which can be based on the energy level on the channel, correlation of signals in the channel, or by using a network allocation vector (NAV) timer. After determining that the channel is idle for a duration of DIFS, STA1 transmits an RTS frame to STA2 after performing backoff. Upon receiving the RTS frame, STA2 responds with a CTS frame after SIFS.

When STA3 receives the RTS frame, it sets its NAV timer for the transmission duration of subsequent frames using the duration information included in the RTS frame. This duration may include SIFS+CTS frame duration+SIFS+data frame duration+SIFS+ACK frame duration. Similarly, when STA3 receives the CTS frame, it sets its NAV timer for the transmission duration of subsequent frames using the duration information included in the CTS frame. If STA3 receives a new frame before the NAV timer expires, it updates the NAV timer using the duration information in the new frame. STA3 does not attempt to access the channel until the NAV timer expires.

After receiving the CTS frame from STA2, STA1 transmits a data frame to STA2 after SIFS elapses from the time the CTS frame was completely received. Upon successfully receiving the data frame, STA2 responds with an ACK frame after SIFS elapses.

When the NAV timer expires, STA3 determines if the channel is busy using carrier sensing techniques. If the channel is not in use by other devices during DIFS and after the NAV timer has expired, STA3 may attempt channel access after a random backoff within a contention window has elapsed.

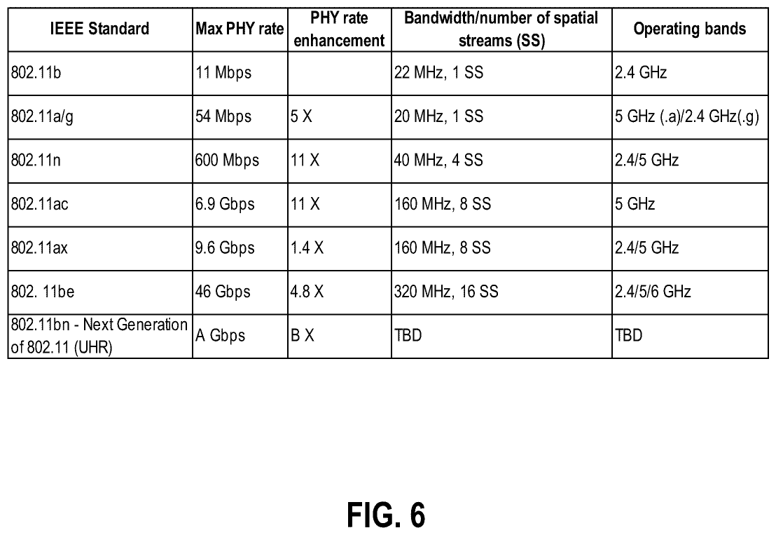

The IEEE 802.11bn (sometimes referred to as “Ultra High Reliability” or just “UHR”) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR.

IEEE 802.11be focuses on WLAN indoor and outdoor operation in the 2.4, 5, and 6 GHz frequency bands, with various candidate features being considered, such as 320 MHZ bandwidth, enhanced multi-band/multi-channel aggregation, 16 spatial streams, enhanced multi-AP coordination, and enhanced link adaptation and retransmission protocols.

The focus of IEEE 802.11bn (UHR) is still under discussion, with candidate features including MLO enhancements, latency and reliability improvements, bandwidth expansion, aggregated PPDU, enhanced multi-link single-radio extensions to access point (AP), roaming improvements, and power-saving schemes.

Some of these features, such as increasing bandwidth and the number of spatial streams, have proven effective in previous projects aimed at increasing link throughput and are considered feasible.

With the availability of the wide 6 GHz unlicensed band (5.925-7.125 GHZ), Wi-Fi devices can access wider bandwidths, enabling larger than 160 MHz data transmissions (e.g., 320 MHz/640 MHz) to increase the maximum PHY rate. This can be achieved by transmitting data in the 6 GHz band or across both the 5 and 6 GHz bands.

In the process of wireless communication, a transmitting station (transmitting STA) creates a physical layer protocol data unit (PPDU) frame and sends it to a receiving station (receiving STA). The receiving STA then receives, detects, and processes the PPDU.

The extremely high throughput physical layer protocol data unit (EHT PPDU) frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

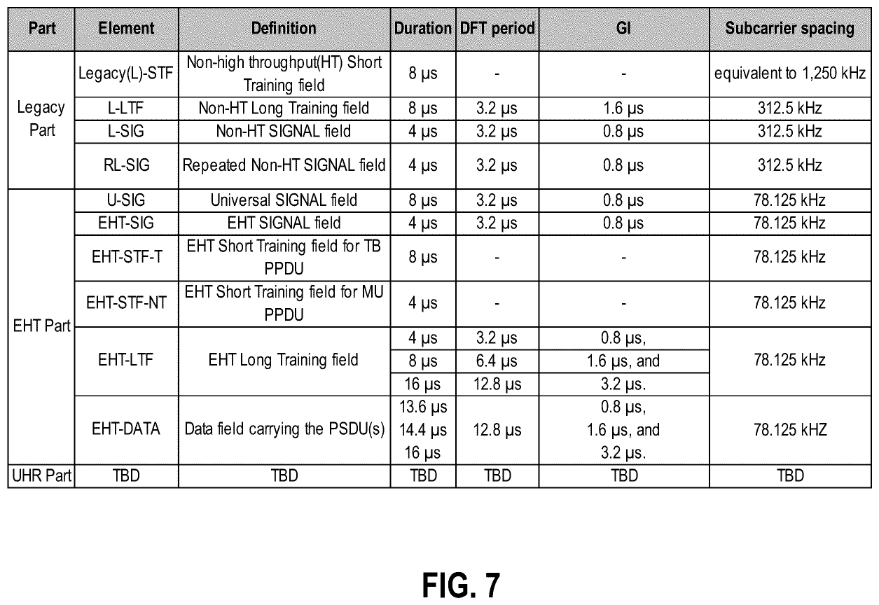

FIG. 7 provides a more detailed description of each field in the EHT PPDU frame, including their purposes and characteristics.

Regarding the Ultra High Reliability physical layer protocol data unit (UHR PPDU), its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a BSS, such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

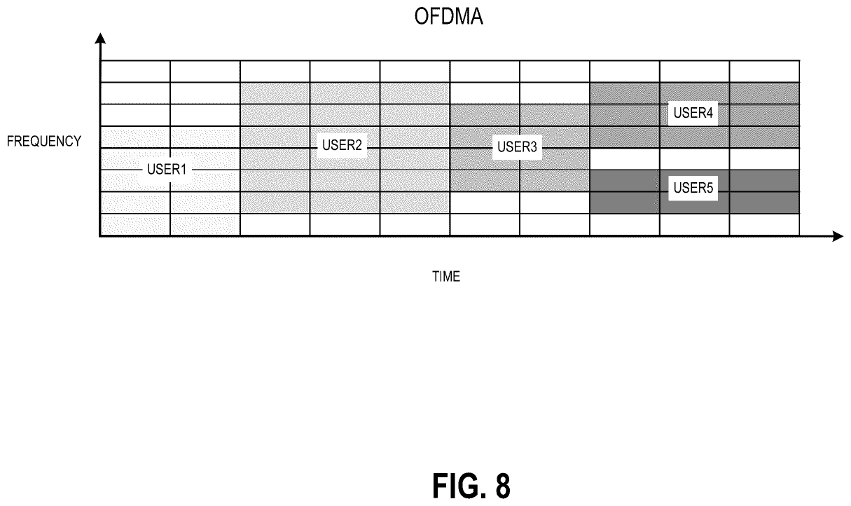

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission (e.g., as depicted in FIG. 8) and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

In the IEEE 802.11ax and 802.11be specifications, the trigger frame plays a useful role in facilitating uplink multi-user (MU) transmissions. The purpose of the trigger frame may be to allocate resources and solicit one or more trigger-based (TB) physical layer protocol data unit (PPDU) transmissions from the associated STAs.

The trigger frame contains information required by the responding STAs to send their uplink TB PPDUs. This information includes the trigger type, which specifics the type of TB PPDU expected, and the uplink length (UL Length), which indicates the duration of the uplink transmission.

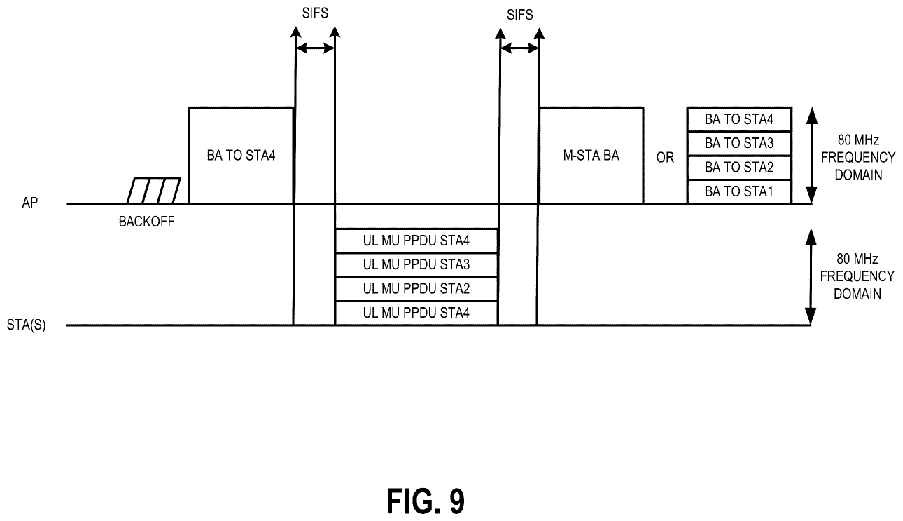

FIG. 9 illustrates an example scenario where an AP operating in an 80 MHz bandwidth environment sends a trigger frame to multiple associated STAs. Upon receiving the trigger frame, the STAs respond by sending their respective uplink orthogonal frequency division multiple access (UL OFDMA) TB PPDUs, utilizing the allocated resources within the specified 80 MHz bandwidth.

After successfully receiving the UL OFDMA TB PPDUs, the access point (AP) acknowledges the stations (STAs) by sending an acknowledgement frame. This acknowledgement can be in the form of an 80 MHz width multi-STA block acknowledgement (Block Ack or BA) or a block acknowledgement with a direct feedback (DF) OFDMA method. The multi-STA block ack allows the AP to acknowledge multiple STAs simultaneously, while the block ack with DF OFDMA enables the AP to provide feedback to the STAs using the same OFDMA technique employed in the uplink transmission.

The trigger frame may be a useful component in enabling efficient uplink MU transmissions in IEEE 802.11ax and 802.11be networks, by allocating resources and coordinating the uplink transmissions from multiple STAs within the same bandwidth.

WLAN systems rely on the retransmission of MAC protocol data units (MPDUs) when the transmitter (TX) does not receive an acknowledgement from the receiver (RX) or when the MPDUs are not successfully decoded at the RX. In the traditional automatic repeat request (ARQ) approach, the receiver discards the last failed MPDU before receiving the new retransmitted one. To meet the requirements of enhanced reliability and reduced latency, the 11be working group decided to evolve this approach toward hybrid ARQ (HARQ).

HARQ processing can be done using two methods: Type 1 HARQ, also known as chase combining (CC), and Type 2 HARQ, also known as incremental redundancy (IR).

In Type 1 HARQ (CC), the retransmitted signals are the same as the previously failed signal because all retransmitted subpackets use the same puncturing pattern. Puncturing removes some parity bits after encoding with an error-correction code. Using the same puncturing pattern in CC-HARQ generates a coded data sequence with forward error correction (FEC) and enables the receiver to use maximum-ratio combining (MRC) to combine the received bits with the same bits from previous transmissions. In WLAN systems, one HARQ packet may be divided into four subpackets. The information sequences are usually transmitted in fixed-length packets, and error correction and detection are performed on the entire packet at the receiver. If the packet is found to be in error, the conventional ARQ scheme may be inefficient when burst errors occur. Applying subpackets can improve this situation more efficiently, as only the subpackets containing errors need to be retransmitted.

The receiver uses both the current and previously received subpackets to decode the packet, reducing the error probability as more subpackets are used. The decoding process passes the CRC check and ends when the packet is decoded without error or when the maximum number of subpackets is reached. Because HARQ operates in a stop-and-wait protocol, the terminal sends an ACK to the transmitter if it can decode the packet, and the transmitter terminates the HARQ transmission upon receiving the ACK correctly. If the terminal cannot decode the packet, it sends a NAK to the transmitter, triggering the retransmission process.

In Type 2 HARQ (IR), different puncturing patterns are used for each subpacket, causing the signal to change for each subpacket. IR uses two puncturing patterns alternately for odd-numbered and even-numbered transmissions, resulting in a coded data sequence with the coding rate used in IR HARQ. The redundancy scheme of IR improves the log likelihood ratio (LLR) of the parity bit by combining information sent across different transmissions and lowers the code rate as additional subpackets are used, leading to a lower error rate compared to CC. The puncturing pattern used in HARQ may be indicated by the subpacket identity (SPID). The first subpacket's SPID may be always set to 0, and it contains all the systematic bits and punctured parity bits, allowing self-decoding when the receiving SNR environment is good. Generally, subpacket SPIDs are transmitted in increasing order but can be exchanged, except for the first SPID.

### Optimizing Transmission Opportunity (TXOP) Usage in Coordinated-Time Division Multiple Access (C-TDMA) Transmission for Enhanced System Throughput

In the development of WLAN systems, AP coordination is being explored as a promising technology to enhance system throughput. This concept is currently under consideration in IEEE 802.11be and IEEE 802.11bn standards. A predefined mechanism for APs is proposed to support various coordination schemes, including OFDMA, time division multiple access (TDMA), spatial reuse, and joint transmission. In the context of C-TDMA, the process may be initiated by a sharing AP, which obtains a TXOP and determines the AP candidate set through the transmission of frames containing AP coordination scheme capabilities. The AP that responds to this initiation may be designated as the shared AP. These roles are sometimes referred to as master/slave or coordinating/coordinated APs, respectively.

The operational aspects of AP coordination schemes are being examined in both IEEE 802.11be and Ultra High Reliability (UHR) contexts. In coordinated beamforming (C-BF), simultaneous transmission from multiple APs on the same frequency resource is facilitated through the coordination and formation of spatial nulls. Coordinated orthogonal frequency division multiple access (C-OFDMA) is being designed to utilize orthogonal frequency resources more efficiently by coordinating and partitioning the spectrum. Joint Transmission (JTX) is being developed to allow multiple APs to transmit concurrently to a single user by sharing data. In Coordinated spatial reuse (C-SR), transmit power adjustments are being implemented across multiple APs or stations (STAs) to mitigate inter-AP interference. These coordination strategies are being pursued with the aim of optimizing the overall efficiency and performance of WLAN systems across various deployment scenarios.

Multi-access point (multi-AP) coordination technology is being evaluated as a feature for IEEE 802.11 standards, including IEEE 802.11be and future Wi-Fi standards. This technology is designed to enhance spectral efficiency while simultaneously reducing transmission delay and latency. Various multi-AP technologies are being considered, including coordinated beamforming/nulling (Co-BF/Nulling), which may be utilized to minimize interference between M-APs through the sharing of channel state information (CSI); joint transmission (JTX), which enables multiple APs to transmit data concurrently as a single virtual AP; and coordinated orthogonal frequency division multiple access/time division multiple access (OFDMA/TDMA) (C-OFDMA/C-TDMA), where time and frequency resources are cooperatively employed to boost system throughput.

Among these technologies, C-TDMA is being regarded as particularly effective in terms of fairness. Higher channel access opportunities are provided by C-TDMA for shared APs (non-TXOP holders) when data transmission is required, compared to other multi-AP technologies. Furthermore, CSI feedback is not necessitated by C-TDMA, unlike Co-BF/Nulling, and its implementation may be less complex than JTX, which is challenged by synchronization issues between APs.

A significant issue is being identified when shared APs are unable to fully utilize their allocated TXOP time. In such instances, a method for returning unused medium resources to the sharing AP (TXOP holder) may be required to prevent resource wastage. Additionally, the mitigation of interference to neighboring BSSs and the network during the returned TXOP duration may be useful.

To address these challenges, a mechanism is disclosed herein for returning TXOP to the sharing AP while the effects on third-party stations (STAs) are taken into consideration. The disclosed approach is aimed at optimizing resource utilization, maintaining fairness, and minimizing interference in multi-AP coordinated networks, with a particular focus on C-TDMA implementations.

Before discussing example embodiments of the disclosed techniques, it should be understood that the solutions described herein are not limited to WLAN systems but can be applied to various network environments, including cellular telecommunication networks and wired networks. These solutions may be implemented in different forms. One embodiment is envisioned as an article of manufacture where instructions are stored on a non-transitory machine-readable medium, such as microelectronic memory. These instructions are designed to be executed by one or more data processing components, generally referred to as processors or processing units, to perform the specified operations. Alternatively, some operations may be carried out by dedicated hardware components with hardwired logic, such as digital filter blocks and state machines. A combination of programmed data processing components and fixed hardwired circuit components may also be employed to perform these operations.

In certain instances, an embodiment may be realized as an apparatus, which could be an access point station (AP STA), a non-AP STA, or another network or computing device. This apparatus may be equipped with one or more hardware and software logic structures capable of executing the described operations. The apparatus typically includes a memory unit where instructions are stored, which are then executed by an installed hardware processor. Additional hardware or software elements may be incorporated into the apparatus, such as a network interface and a display device. It should be noted that the term “Station” (STA) may be used in the context of IEEE 802.11 networks to refer to any device that contains an IEEE 802.11-conformant MAC and PHY interface to the wireless medium.

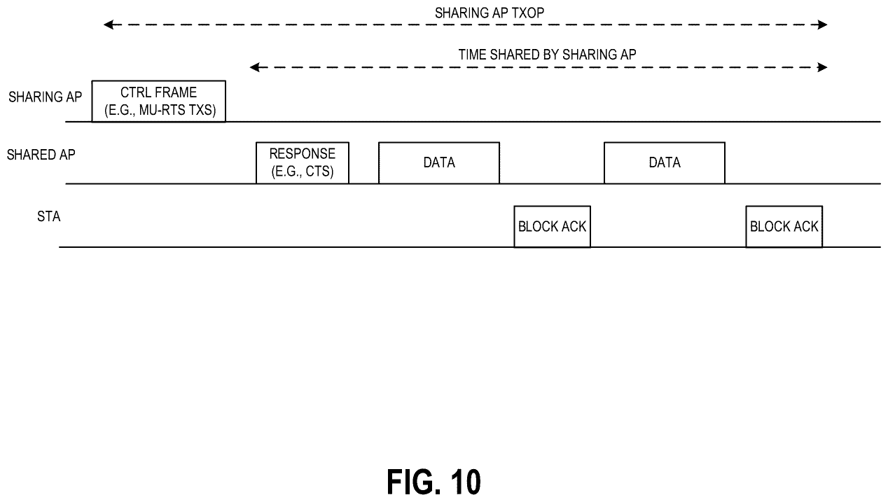

Turning now to FIG. 10, it illustrates an example TXOP sharing frame sequence in C-TDMA, in accordance with some embodiments of the present disclosure.

In FIG. 10, a common TXOP sharing frame sequence is depicted for a C-TDMA scenario. The roles of the access points (APs) are delineated, with the sharing AP designated as the TXOP holder and the shared AP as the TXOP responder. The sequence may be initiated with a prepare phase, during which the required allocation time may be reported by the shared AP to the sharing AP. Following this, a control frame may be transmitted by the sharing AP to facilitate TXOP sharing with the shared AP.

Within this control frame, the time duration allocated to the shared AP may be specified, which may be derived from the TXOP obtained by the sharing AP and based on the previously reported information. The allocated time period may be utilized by the shared AP for the transmission of physical protocol data units (PPDUs) or the solicitation of PPDUs, such as trigger-based PPDUs. Upon the expiration of the allocated time duration that was shared with the shared AP, transmission may be resumed by the sharing AP.

In the context of wireless network resource allocation, the allocated TXOP may not be fully utilized by the shared access point (AP). This situation can arise due to various circumstances, with a prime example being the absence of additional data for transmission by the shared AP.

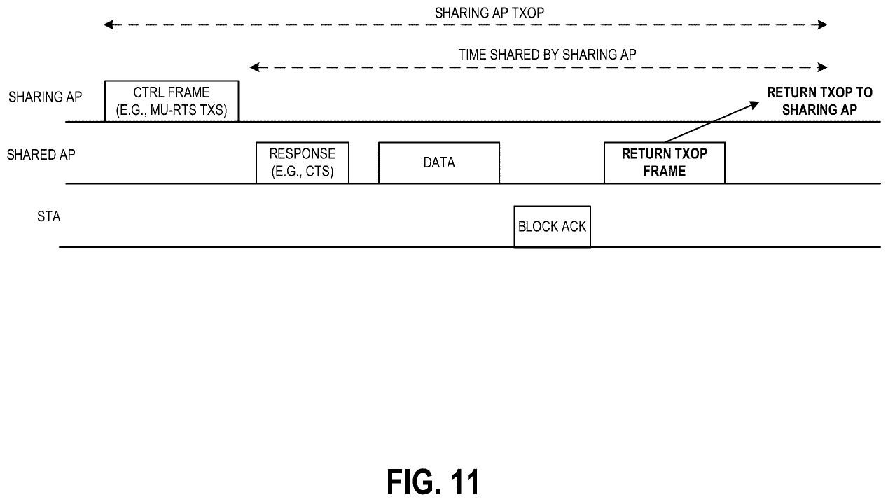

To address this inefficiency and optimize medium usage, a mechanism for returning the unused portion of the TXOP to the sharing AP is disclosed herein. This process is visually represented in FIG. 11 which illustrates an example of returning a remaining TXOP from a shared AP to a sharing AP, in accordance with some embodiments of the present disclosure.

In FIG. 11, the operational flow of TXOP return from the shared AP to the sharing AP is illustrated. Upon receipt of the returned TXOP, at least two potential courses of action are available to the sharing AP: (1) the resumption of its own transmission of buffered units, or (2) the reallocation of the returned TXOP to an alternative AP within the network. Through this mechanism, waste of unused time may be prevented, and the efficient utilization of network resources may be promoted. Consequently, the overall medium usage may be optimized, leading to improved network performance and throughput.

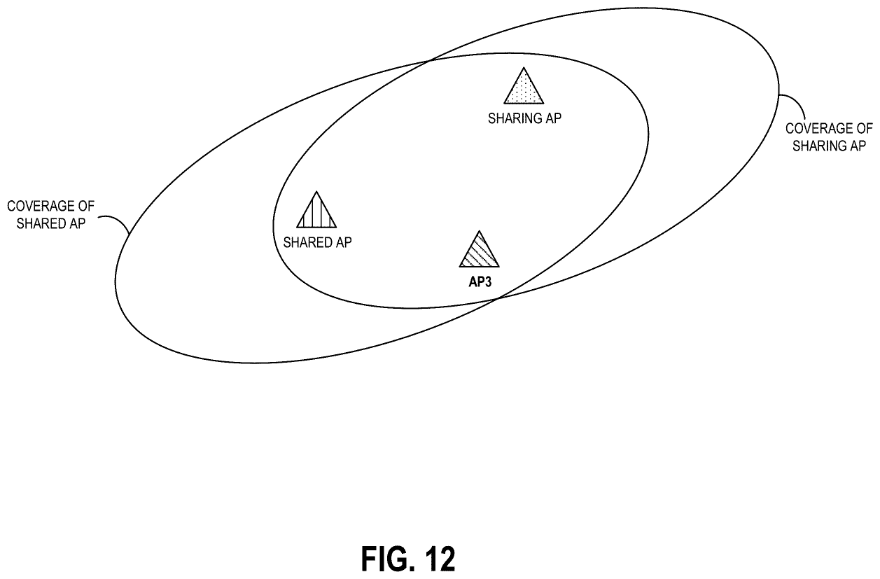

In wireless network environments with multiple access points (APs), the process of returning unused TXOP may be complicated by the presence of third-party stations (STAs). FIG. 12 illustrates an example wireless network topology when a third-party station can overhear PPDUs between a sharing AP and a shared AP, in accordance with some embodiments of the present disclosure.

A scenario is illustrated in FIG. 12, where a network topology is depicted in which physical layer protocol data units (PPDUs) exchanged between a sharing AP and a shared AP can be overheard by a third-party STA, exemplified as AP3. This overhearing capability extends to the return TXOP frame, as shown in FIG. 11. An issue arises when the return TXOP frame triggers a reset or release of the Network Allocation Vector (NAV) counter in adjacent devices.

In such instances, channel medium occupation may be attempted by AP3, potentially causing interference with the frame exchange sequence of the sharing AP during the returned TXOP period. To mitigate this risk, channel access by AP3 may be deferred until the conclusion of the returned TXOP duration.

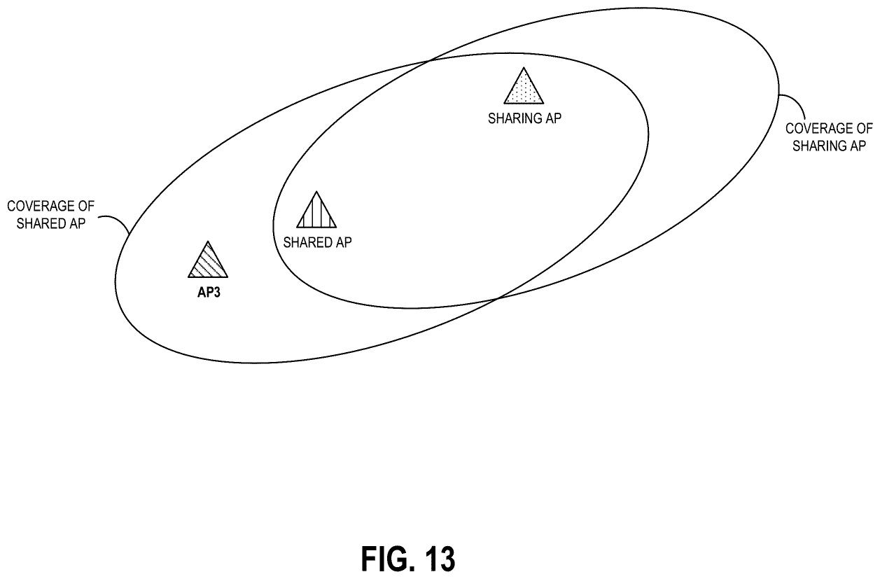

FIG. 13 illustrates an example wireless network topology when a third-party station can overhear PPDUs of a shared AP but cannot overhead PPDUs of a sharing AP, in accordance with some embodiments of the present disclosure.

Another complex scenario in wireless network topology is presented, as illustrated in FIG. 13, where a third-party station (STA), exemplified by AP3, may be capable of overhearing physical layer protocol data units (PPDUs) from a shared access point (AP) but not those from a sharing AP. In this configuration, channel access may be deferred by AP3 during the returned TXOP duration, despite the potential for channel medium access.

However, a significant inefficiency may be identified from AP3's perspective: if channel access is deferred after the TXOP has been returned to the sharing AP, channel resources may be wasted, and system throughput potentially decreased. This inefficiency may be attributed to the lack of mutual interference between AP3 and the sharing AP at that specific time instance.

To address this issue and optimize channel resource utilization, AP3 may be notified of its ability to attempt channel access during the returned TXOP duration. The aim of this approach is to enhance overall system efficiency by enabling AP3 to utilize the channel when its transmissions would not cause interference with those of the sharing AP.

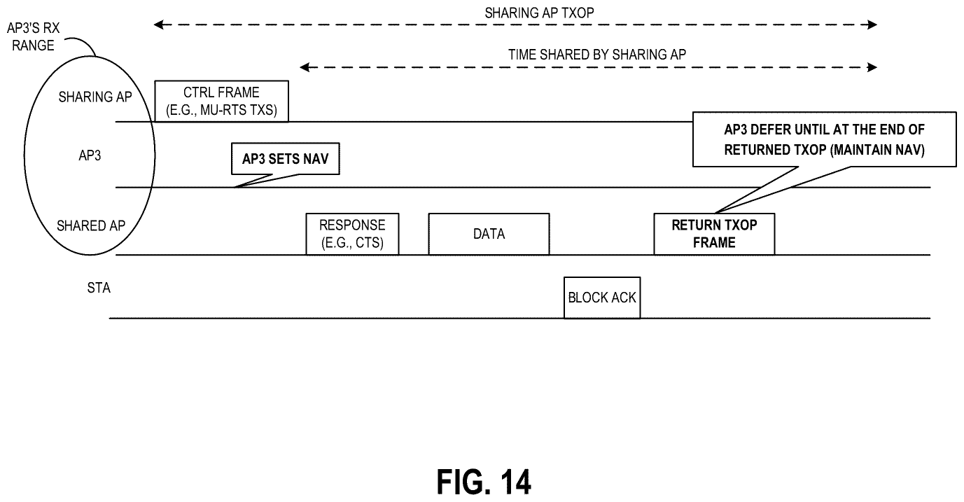

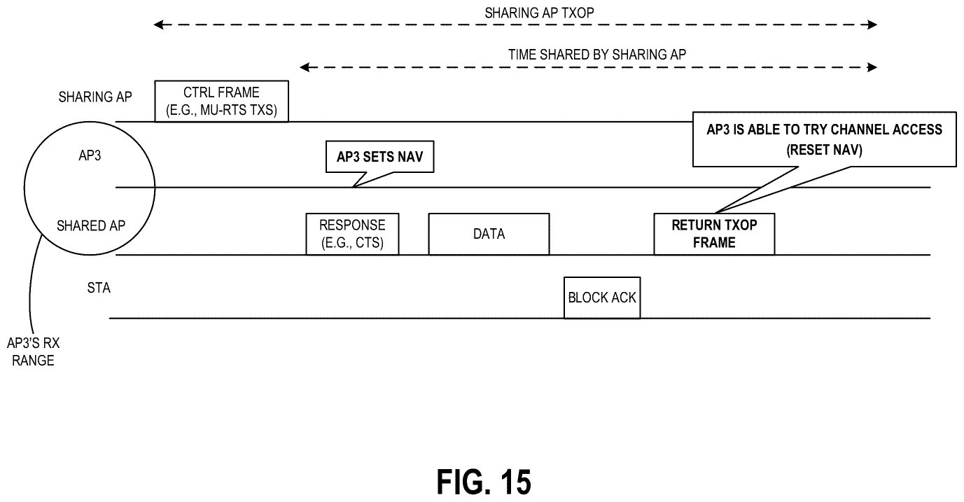

FIG. 14 illustrates an example signaling design of a return TXOP sequence while considering the third-party station in the network topology of FIG. 12, in accordance with some embodiments of the present disclosure. FIG. 15 illustrates an example signaling design of a return TXOP sequence while considering the third-party station in the network topology of FIG. 13, in accordance with some embodiments of the present disclosure.

In FIG. 14 and FIG. 15, example signaling designs for the return TXOP sequence are illustrated, considering the presence of third-party stations (STAs), such as AP3, in accordance with the network topologies depicted in FIG. 12 and FIG. 13. These signaling designs address the complexities introduced by multi-access point (AP) environments in C-TDMA scenarios.

Based on the considerations presented in these signaling designs and mechanisms, a return TXOP frame is proposed. The primary objective of this return TXOP frame may be to mitigate collisions and reduce adverse effects between APs participating in C-TDMA and third-party STAs.

The return TXOP frame, as depicted in FIG. 11, is proposed to be designed using various potential frame structures. One option is the multi-user request to send transmit start/transmit sharing opportunity (MU-RTS TXS) frame, which could be utilized as the control frame (Ctrl frame) illustrated in FIG. 11 when TXOP allocation from the sharing AP to the shared AP occurs. Alternatively, the return TXOP frame could be implemented as a new, modified, or existing control frame, such as, for example, the contention free end (CF-End) frame.

These options are aimed at optimizing the TXOP return process in C-TDMA scenarios. The flexibility in frame design may be intended to accommodate various network topologies and operational requirements, allowing for efficient signaling and resource management in complex multi-AP environments. By leveraging existing frame structures or developing new ones, it may be expected that the return TXOP mechanism can be integrated into current wireless networking protocols while addressing the specific challenges posed by C-TDMA implementations.

### MU-RTS TXS Frame Option

One option for the return TXOP frame utilizes the multi-user request to send transmit start/transmit sharing opportunity (MU-RTS TXS) frame structure. In this design, a subfield may be introduced to indicate whether the frame is used for original TXOP sharing or TXOP return. A bit indication system may be implemented, where 0 signifies original TXOP sharing (from sharing access point (AP) to shared AP) and 1 indicates TXOP return (from shared AP to sharing AP).

In the topology illustrated in FIG. 12, a third-party station (STA), such as AP3, can overhear the initial MU-RTS TXS frame from the sharing AP to the shared AP. The bit indication (0) may be recognized and stored by AP3. Subsequently, when a return TXOP frame is overheard, AP3 identifies it as such due to the bit indication (1). By comparing these bit indications, AP3 determines that it has overheard frames from both the sharing and shared APs, corresponding to the sequence in FIG. 14. In this scenario, AP3 should defer transmission by maintaining its network allocation vector (NAV) counter to avoid collisions with the sharing AP reclaiming the TXOP.

Conversely, in the FIG. 13 topology, AP3 cannot overhear the initial MU-RTS TXS frame. When it subsequently overhears a return TXOP frame with bit indication 1, AP3 recognizes this as the scenario depicted in FIG. 15. In this case, AP3 resets its NAV to resume channel access.

Additionally, the ‘allocation duration’ subfield in the user info field of the MU-RTS TXS frame may be repurposed for TXOP return. This modification allows the sharing AP, which may not have retained its original TXOP duration after handover to the shared AP, to be explicitly informed of the returned TXOP duration.

### CF-END Frame Option

Another option for the return TXOP frame utilizes either a newly defined control frame or an existing one, such as the contention free end (CF-End) frame. In this design, a subfield may be included to indicate the destination of the returned TXOP. The purpose of this subfield may be twofold: (1) to prompt the returned TXOP access point (AP) to transmit a self-clear to send (CTS) frame within a SIFS or PIFS after receiving the return TXOP frame, and (2) to trigger network allocation vector (NAV) reset in third-party stations (STAs).

In the topology illustrated in FIG. 12, when the sharing AP receives the return TXOP frame, it may be overheard by the third-party STA (e.g., AP3). Although AP3 resets its NAV upon overhearing this new control frame, the sharing AP's transmission of a self-CTS frame within the SIFS/PIFS interval causes AP3 to set its NAV until the end of the returned TXOP duration, thereby avoiding collisions with the sharing AP.

Conversely, in the FIG. 13 topology, while the sharing AP still receives the return TXOP frame and transmits a self-CTS frame, AP3 cannot overhear this self-CTS frame. Consequently, AP3 can attempt channel access after overhearing the return TXOP frame, potentially improving medium efficiency.

In scenarios where an existing control frame like the CF-End frame is utilized, the sharing AP interprets the reception of a CF-End frame addressed to it as a return TXOP situation. To maintain channel exclusivity, the sharing AP transmits a dedicated frame (e.g., self-CTS). However, if adjacent STAs of the shared AP overhear only the CF-End frame and not the Self-CTS frame, their NAV counters remain reset, allowing them to attempt channel occupation.

### Modified CF-END Frame Option

Yet another option for the return TXOP frame modifies an existing control frame, such as the contention free end (CF-End) frame. In this design, the transmitter address (TA) field of the CF-End frame may be repurposed to indicate the transmitting station's address. This field could contain the BSS Identifier (BSSID) of the shared access point (AP), a group BSSID shared between the sharing and shared APs, or the shared AP's AP identifier (AP-ID). Additionally, the duration field in the CF-End frame may be utilized to indicate the remaining TXOP, which can be used by the sharing AP for transmitting or soliciting physical layer protocol data units (PPDUs) within its BSS after receiving the modified CF-End frame.

Upon reception of the modified CF-End frame from the shared AP, the TA field may be checked by the sharing AP. If the TA field matches the shared AP's BSSID/AP-ID or the group BSSID, PPDUs can be transmitted by the sharing AP within a SIFS or PIFS interval. The shared AP's BSSID/AP-ID or group BSSID, initially used in the multi-user request to send transmit start/transmit sharing opportunity (MU-RTS TXS) frame transmission, can be saved by the sharing AP for comparison with the TA field of the modified CF-End frame.

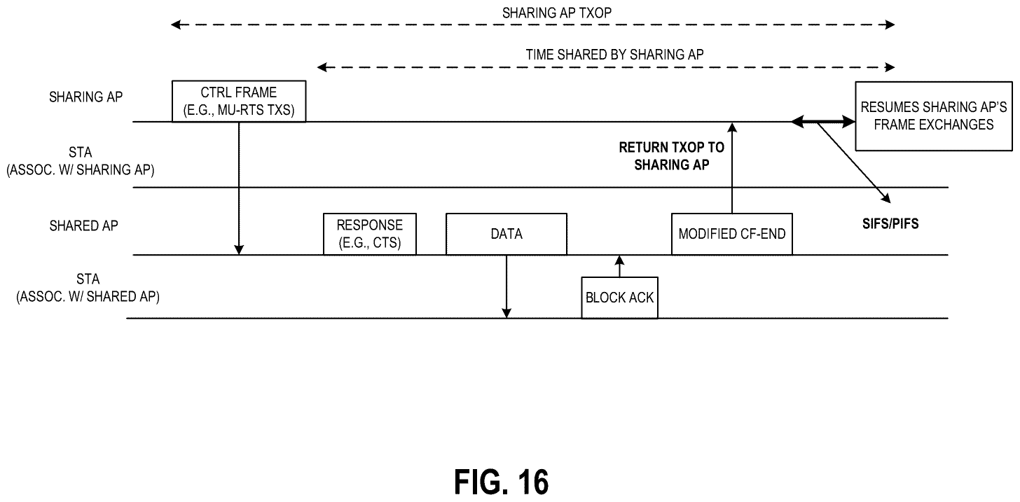

FIG. 16 illustrates an example of a modified control frame as a return TXOP frame, in accordance with some embodiments of the present disclosure.

In the topology illustrated in FIG. 12, when the modified CF-End frame is received by the sharing AP (as shown in FIG. 16), it can be overheard by the third-party station (AP3), causing a reset of its network allocation vector (NAV). Despite this NAV reset, the sharing AP can transmit within a SIFS/PIFS interval after receiving the modified CF-End frame, allowing the use of the returned TXOP duration without collisions with AP3.

Conversely, in the FIG. 13 topology, when the modified CF-End frame is received by the sharing AP (as shown in FIG. 16), it can be overheard by AP3, resulting in a NAV reset. Since AP3 cannot overhear any PPDUs from the sharing AP in this topology, it can attempt channel access, potentially improving medium efficiency.

### Example Methods

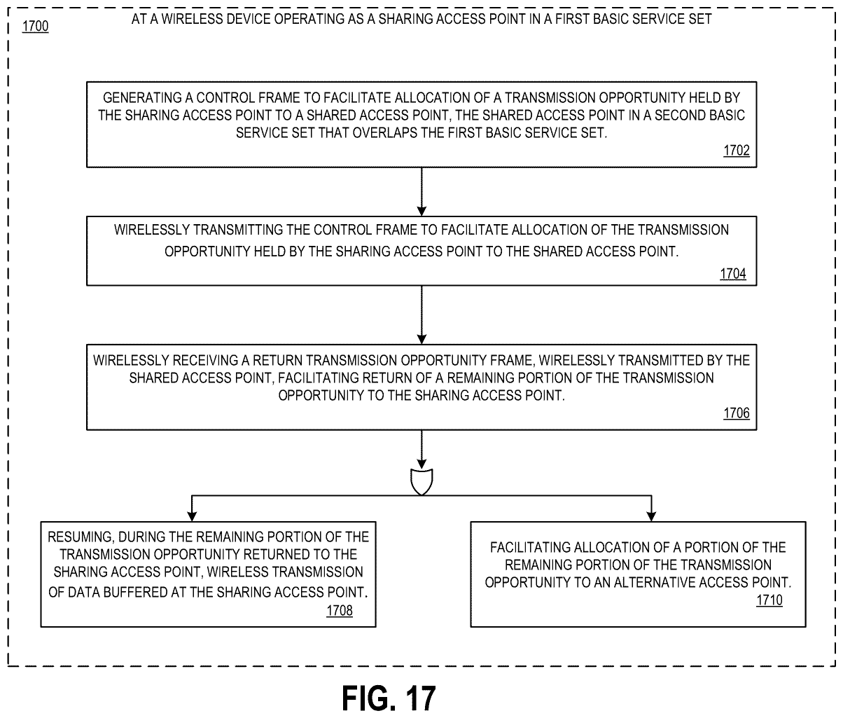

FIG. 17 illustrates an example method 1700 performed by a wireless device functioning as a sharing access point (AP) in a first basic service set (BSS). Method 1700 encompasses a process for dynamic transmission opportunity (TXOP) sharing and reclamation in overlapping Wi-Fi networks. At step 1702, the sharing AP initiates the process by generating a control frame designed to allocate its TXOP to a shared AP located in a second, overlapping BSS. At step 1704, this control frame is then wirelessly transmitted to facilitate the TXOP allocation. Subsequently, at step 1706, the sharing AP receives a return TXOP frame from the shared AP, indicating that a portion of the originally allocated TXOP remains unused and is being returned.

Upon receiving this frame, the sharing AP has at least two, not inherently exclusive, options for utilizing the returned TXOP: it can resume (step 1708) its own wireless data transmission using the buffered data at the sharing AP, or it can reallocate (step 1710) a portion of the returned TXOP to an alternative AP.

This method 1700 exemplifies advanced coordination techniques in dense wireless networking environments, allowing for more efficient use of channel resources by enabling dynamic TXOP sharing and reclamation between overlapping BSSs. It addresses the challenges of spectrum efficiency and network coordination in scenarios where multiple APs operate in close proximity, potentially improving overall network performance and reducing interference.

In the context of method 1700, a sharing access point (AP) may encompass a wireless device operating within a specific basic service set (BSS) that has obtained a transmission opportunity (TXOP) and is capable of dynamically allocating this resource to other APs in overlapping BSSs. This sharing AP plays a useful role in coordinated multi-AP operations, particularly in dense wireless networking deployments where efficient spectrum utilization is paramount.

The sharing AP may initiate the TXOP sharing process by generating and transmitting a control frame, which may contain information for the allocation of its TXOP to a designated shared AP in an overlapping BSS. This mechanism allows for temporary resource sharing across different BSSs, potentially improving overall network efficiency. According to method 1700, the sharing AP may maintain the ability to reclaim any unused portion of the shared TXOP, as evidenced by its capability to receive a return TXOP frame from the shared AP. Upon reclaiming the TXOP, the sharing AP can resume its own transmissions or further redistribute the reclaimed resource to other APs.

In the context of method 1700, a shared access point (AP) may encompass a wireless device operating in a second basic service set (BSS) that overlaps with the BSS of the sharing AP. The shared AP may be the recipient of a dynamically allocated transmission opportunity (TXOP) from the sharing AP.

The shared AP may not initially hold the TXOP but may receive it through a control frame transmitted by the sharing AP. This allocation may allow the shared AP to temporarily utilize channel resources originally obtained by the sharing AP. The shared AP may be capable of using the allocated TXOP for its own transmissions or for facilitating transmissions from stations within its BSS.

The shared AP may return any unused portion of the allocated TXOP to the sharing AP. This may be accomplished through the transmission of a return TXOP frame, which signals to the sharing AP that the remaining TXOP duration is available for reclamation. This mechanism enables efficient use of spectrum resources and allows for dynamic adaptation to varying traffic demands across different BSSs.

In the context of method 1700, the step 1702 of generating a control frame is an initiating action in the process of transmission opportunity (TXOP) sharing between overlapping basic service sets (BSSs) in a wireless network. This step 1702 is performed by a wireless device functioning as a sharing access point (AP) within its own BSS.

The control frame generated may be a specialized management frame designed to convey information necessary for TXOP allocation. It may contain details such as the duration of the TXOP being shared, the identity of the intended recipient (the shared AP), and potentially other parameters required for coordinated operation. This frame serves as a mechanism for the sharing AP to explicitly signal its intention to temporarily relinquish its TXOP to another AP in a different, overlapping BSS.

A purpose of this control frame may be to facilitate allocation of the TXOP by providing information and permissions for the shared AP to utilize the channel during the specified time period. This facilitation is useful in coordinated multi-AP environments, where efficient spectrum utilization requires precise timing and clear communication between APs.

In the context of method 1700, the step 1704 of wirelessly transmitting the control frame is an action in the process of transmission opportunity (TXOP) sharing between overlapping basic service sets (BSSs) in a Wi-Fi network. This step 1704 is executed by the wireless device operating as a sharing access point (AP) within its own BSS.

The wireless transmission of the control frame is the practical implementation of the TXOP allocation mechanism. This action may involve sending the previously generated control frame over the wireless medium, for example, using the sharing AP's radio transmitter. The frame may be broadcast or unicast, depending on the specific protocol, to ensure it reaches the intended shared AP in the overlapping BSS.

The wireless transmission is not just a simple data transfer but a coordinated action to enable the temporary reassignment of channel access rights. By transmitting this frame, the sharing AP may effectively signal to the shared AP and potentially other devices in the vicinity that a portion of its TXOP is being made available for use by the shared AP.

This transmission may occur using specific PHY layer parameters to ensure reliable reception, possibly utilizing management frame protection mechanisms to maintain integrity. The timing of this transmission may occur at a point that allows the shared AP sufficient time to prepare for utilizing the allocated TXOP.

In the context of method 1700, the step 1706 of wirelessly receiving a return transmission opportunity frame represents a phase in the dynamic management of shared spectrum resources between overlapping basic service sets (BSSs) in a wireless network. This step 1704 may be executed by the wireless device functioning as the sharing access point (AP) in its BSS.

The return transmission opportunity (TXOP) frame may be a specialized control frame transmitted by the shared AP to signal that it has completed its use of the allocated TXOP before the full duration has expired. This frame may contain information about the remaining portion of the TXOP that is being returned to the original sharing AP. The wireless reception of this frame may involve the sharing AP's radio receiver detecting, demodulating, and decoding the signal transmitted by the shared AP.

This return frame may serve as a mechanism for the shared AP to relinquish control of the channel back to the sharing AP. This allows for efficient use of airtime, as any unused portion of the TXOP can be reclaimed and repurposed.

In the context of method 1700, the sharing access point's (AP) may adaptively respond to reclaiming the remaining portion of a previously allocated transmission opportunity (TXOP).

One response option involves the sharing AP resuming (step 1708) its own wireless transmissions using the reclaimed TXOP portion. This action may utilize the sharing AP's buffer, which may contain data frames that were queued during the TXOP sharing period. By immediately leveraging the returned airtime, the sharing AP may maximize channel utilization and potentially reduce latency for its own buffered traffic. This option may be particularly beneficial in scenarios where the sharing AP has accumulated a significant amount of data during the sharing period or has high-priority traffic waiting to be transmitted.

Another response option that is not necessarily exclusive of the response option of step 1708 is for the sharing AP to further distribute (step 1710) the reclaimed TXOP portion to another AP (an AP other than the original shared AP). This option could be advantageous in complex network topologies with multiple overlapping BSSs, where dynamic redistribution of channel access time can lead to overall improved network performance.

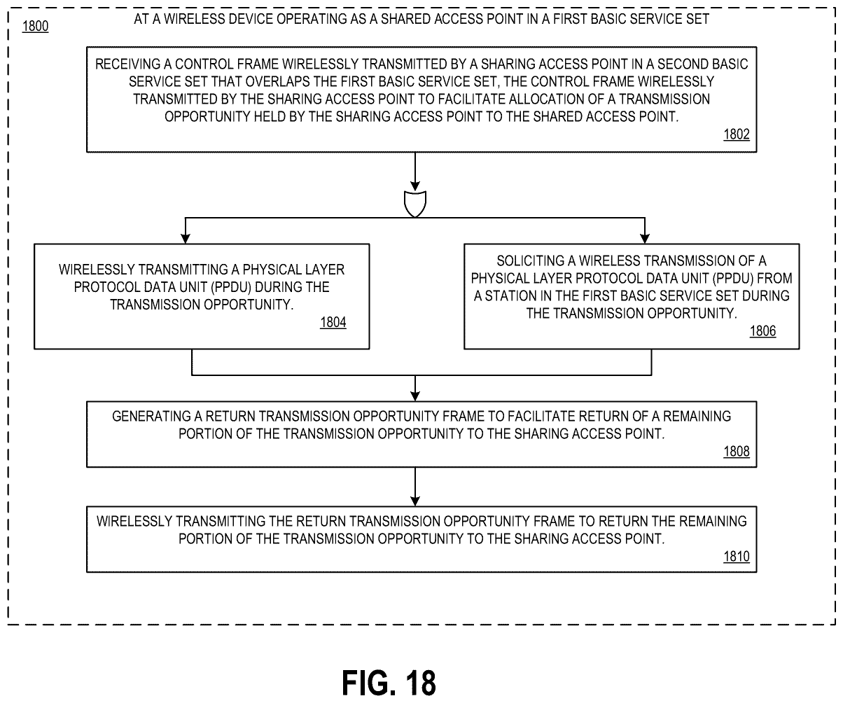

FIG. 18 illustrates an example method 1800 executed by a wireless device functioning as a shared access point (AP) in a first basic service set (BSS). The method 1800 delineates a process for receiving, utilizing, and returning a transmission opportunity (TXOP) in overlapping wireless networks. The shared AP initially receives (step 1802) a control frame wirelessly transmitted by a sharing AP located in a second, overlapping BSS. This control frame is designed to facilitate the allocation of a TXOP from the sharing AP to the shared AP. Upon receiving the allocated TXOP, the shared AP has at least two not necessarily exclusive options for its utilization: it can wirelessly transmit (step 1804) its own physical layer protocol data unit (PPDU) during the TXOP, or it can solicit (step 1806) a wireless PPDU transmission from a station within its BSS. After utilizing a portion of the allocated TXOP, the shared AP generates (step 1808) a return TXOP frame. This frame is crafted to facilitate the return of any unused portion of the TXOP to the original sharing AP. Finally, the shared AP wirelessly transmits (step 1810) this return TXOP frame, effectively returning the remaining portion of the TXOP to the sharing AP.

This method 1800 exemplifies coordination techniques in dense wireless networking deployments, enabling efficient use of channel resources through dynamic TXOP sharing and reclamation between overlapping BSSs. It addresses challenges related to spectrum efficiency and network coordination in scenarios with multiple proximate APs, enhancing overall network performance and mitigating interference.

In the context of method 1800, the shared access point (AP) may be a wireless device operating within a first basic service set (BSS) that participates in a coordinated transmission opportunity (TXOP) sharing mechanism with a sharing AP from an overlapping BSS. The shared AP may be the recipient of a TXOP allocation initiated by the sharing AP. It may receive a control frame wirelessly transmitted by the sharing AP, which contains the necessary information to utilize the allocated TXOP. Upon receiving this allocation, the shared AP has the flexibility to either transmit its own physical layer protocol data units (PPDUs) or to solicit PPDU transmissions from stations within its BSS during the allocated TXOP period. Further, the shared AP has the ability to dynamically manage the allocated TXOP. If it completes its transmissions before the TXOP expires, the shared AP may return the unused portion of the TXOP to the sharing AP. This may be accomplished by generating and transmitting a return TXOP frame, which facilitates the efficient reuse of channel resources.

In the context of method 1800, the sharing access point (AP) may be a wireless device operating in a second basic service set (BSS) that overlaps with the BSS of the shared AP. Although the sharing AP may initiate and facilitate the coordinated transmission opportunity (TXOP) sharing process. The sharing AP may be responsible for generating and wirelessly transmitting a control frame to the shared AP. This control frame may contain information for allocating a portion of the TXOP originally held by the sharing AP to the shared AP. The sharing AP, having obtained a TXOP through channel access mechanisms, may make a decision to temporarily relinquish part or all of its TXOP to the shared AP. This decision may be based on various factors such as network load, quality of service requirements, and overall system optimization goals. The sharing AP may be the intended recipient of the return TXOP frame transmitted by the shared AP. The sharing AP may maintain state date reflecting awareness of the allocated TXOP and may be configured to reclaim any unused portion.

In the context of method 1800, the step of receiving (step 1802) a control frame is an initiating action for the shared access point (AP) in the process of transmission opportunity (TXOP) sharing between overlapping basic service sets (BSSs) in a wireless network. This step (1802) is performed by a wireless device functioning as the shared AP within its own BSS. The control frame may be wirelessly transmitted by a sharing AP located in a second, overlapping BSS. This frame may be a specialized management frame designed to convey information necessary for TXOP allocation. The reception of this frame may involve the shared AP's radio receiver detecting, demodulating, and decoding the signal transmitted by the sharing AP. A purpose of this control frame may be to facilitate allocation of the TXOP, indicating that it provides information and permissions for the shared AP to utilize the channel during a specified time period. This frame may contain details such as the duration of the TXOP being shared, any restrictions or parameters for its use, and potentially other coordination information.

In the context of the method 1800, the shared access point (AP) utilizes the allocated transmission opportunity (TXOP) received from the sharing AP. At least two not necessarily exclusive actions include, as one option, the shared AP wirelessly transmitting (1804) its own Physical Layer Protocol Data Unit (PPDU) during the allocated TXOP. A PPDU may be a complete unit of data at the physical layer, including preamble, header, and payload. This option may allow the shared AP to directly utilize the granted airtime for its own data transmission needs, which could include sending buffered data, management frames, or control information to stations within its Basic Service Set (BSS). Another option is where the shared AP solicits (1806) a wireless PPDU transmission from a station within its BSS during the allocated TXOP. This option uses the shared AP's ability to redistribute the granted channel access to its associated stations. The solicitation may involve sending a trigger frame or similar control message to a specific station, prompting it to transmit its data within the allocated TXOP.

Both options demonstrate the efficient use of the shared spectrum resource. The choice between these options may depend on various factors such as the current traffic demands within the shared AP's BSS, quality of service requirements, and the nature of pending data transmissions.

In the context of method 1800, the shared access point (AP) generates (1808) a return transmission opportunity (TXOP) frame. This action may be part of the dynamic TXOP sharing mechanism in wireless networks with overlapping basic service sets (BSSs). The generation of this frame may occur when the shared AP has completed its use of the allocated TXOP before the full duration has expired, or when it determines that it no longer requires the remaining TXOP time. The return TXOP frame may be a specialized control frame designed to convey information about the unused portion of the TXOP back to the original sharing AP. This frame may include several pieces of information including any or all of the identity of the sharing AP (the intended recipient), the duration of the remaining TXOP being returned, or a reason code or other metadata about the TXOP usage. This frame may serve as the mechanism for the shared AP to relinquish control of the channel back to the sharing AP. This may allow for efficient use of airtime, as any unused portion of the TXOP can be reclaimed and repurposed by the original holder or potentially reallocated to other devices.

In the context of method 1800, the step 1810 involves the shared access point (AP) wirelessly transmitting the return transmission opportunity (TXOP) frame. This action may be a component in the dynamic TXOP sharing mechanism between overlapping basic service sets (BSSs) in advanced Wi-Fi networks. The wireless transmission of the return TXOP frame may be the practical implementation of the TXOP return process. It may involve the shared AP using its radio transmitter to send the previously generated return TXOP frame over the wireless medium. This frame may be transmitted using specific physical layer (PHY) parameters to ensure reliable reception by the sharing AP, potentially utilizing management frame protection mechanisms to maintain integrity. The transmission is not just a simple data transfer but a coordinated action to relinquish control of the unused TXOP back to the sharing AP. This transmission may signal to the sharing AP and potentially other devices in the vicinity that the shared AP has completed its use of the allocated TXOP before the full duration has expired. The timing of this transmission may occur promptly after the shared AP determines it no longer needs the TXOP, allowing the sharing AP sufficient time to reclaim and potentially repurpose the returned airtime.

### Other Considerations

In the present disclosure, a novel mechanism is proposed for the management of TXOP returns in multi-Access Point (AP) environments. The mechanism is designed to enable a shared AP to return unused TXOP to a sharing AP without inducing collisions or adverse effects on third-party stations (STAs).

Flexibility in handling diverse network scenarios is offered by the proposed mechanism. In certain situations, third-party STAs are allowed to reset their Network Allocation Vector (NAV) and attempt channel access, a feature that can potentially enhance medium efficiency. Conversely, in other scenarios, the maintenance of NAV by third-party STAs is facilitated to prevent collisions with the sharing AP.

Through this adaptive approach, the resumption of frame exchanges by the sharing AP is ensured without risking collisions with third-party STAs. The implementation of the proposed frame design is expected to significantly improve both medium access efficiency and operational flexibility within the network.

The complexities inherent in TXOP management within multi-AP environments are addressed by this mechanism, which provides a solution that balances the requirements of various network participants while optimizing overall system performance. This approach represents a significant advancement in the field of wireless network resource management, offering a more nuanced and efficient method for handling TXOP returns in complex network topologies.

The solutions presented in this document have been described in the context of a wireless LAN system. However, it is important to note that these solutions are not limited to wireless LANs and can be applied to other network environments, such as cellular telecommunication networks and wired networks.

An embodiment of the present disclosure may take the form of an article of manufacture, where a non-transitory machine-readable medium, such as microelectronic memory, stores instructions that program one or more data processing components, referred to as a “processor” or “processing unit,” to perform the operations described earlier. In other embodiments, some of these operations might be carried out by specific hardware components containing hardwired logic, such as dedicated digital filter blocks and state machines. Alternatively, these operations could be performed by a combination of programmed data processing components and fixed hardwired circuit components.

In some cases, an embodiment of the invention may be an apparatus, such as an access point station (AP STA), a non-AP station (non-AP STA), or another network or computing device, that includes one or more hardware and software logic structures for performing one or more of the described operations. For example, as previously mentioned, the apparatus may include a memory unit that stores instructions executable by a hardware processor installed in the apparatus. The apparatus may also incorporate additional hardware or software elements, such as a network interface or a display device.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art.

An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a wireless device operating as a sharing access point in a first basic service set, the method comprising:
generating a control frame to facilitate allocation of a transmission opportunity held by the sharing access point to a shared access point, the shared access point in a second basic service set that overlaps the first basic service set;
wirelessly transmitting the control frame to facilitate allocation of the transmission opportunity held by the sharing access point to the shared access point;
wirelessly receiving a return transmission opportunity frame, wirelessly transmitted by the shared access point, facilitating return of a remaining portion of the transmission opportunity to the sharing access point; and
(a) resuming, during the remaining portion of the transmission opportunity returned to the sharing access point, wireless transmission of data buffered at the sharing access point, or (b) facilitating allocation of a portion of the remaining portion of the transmission opportunity to an alternative access point.

2. The method of claim 1, wherein:
the control frame comprises a particular bit having a particular bit value indicating that the control frame is facilitating allocation of the transmission opportunity held by the sharing access point to the shared access point;
the return transmission opportunity frame comprises the particular bit having an opposite bit value of the particular bit value indicating that the return transmission opportunity frame is facilitating return of the portion of the transmission opportunity to the sharing access point; and
a third-party access point, based on overhearing both the control frame and the return transmission opportunity frame with the particular bit, defers a wireless transmission until after the transmission opportunity thereby avoiding a collision with the sharing AP during the remaining portion of the transmission opportunity returned to the sharing AP.

3. The method of claim 1, wherein:
the return transmission opportunity frame comprises a particular bit having a particular bit value indicating that the return transmission opportunity frame is facilitating return of the portion of the transmission opportunity to the sharing access point;
the sharing access point wirelessly transmits a physical layer protocol data unit (PPDU) during the remaining portion of the transmission opportunity returned to the sharing AP;
the third-party access point does not overhear the physical layer protocol data unit (PPDU) wirelessly transmitted by the sharing access point during the remaining portion of the transmission opportunity returned to the sharing AP; and
the third-party access point, based on overhearing the return transmission opportunity frame with the particular bit value, attempts a channel access during the remaining portion of the transmission opportunity returned to the sharing AP.

4. The method of claim 1, wherein an allocation duration field of the return transmission opportunity frame is used to indicate a duration of the remaining portion of the transmission opportunity being returned to the sharing access point.

5. The method of claim 1, wherein:
the return transmission opportunity frame comprises a particular field for prompting the sharing access point to wirelessly transmit a clear-to-send frame within a short interframe space time interval or a point coordination function interframe space time interval after wirelessly receiving the return transmission opportunity frame;
the method further comprises: in response to the sharing access point wirelessly receiving the return transmission opportunity frame with the particular field, the sharing access point generating the clear-to-send frame, and the sharing access point wirelessly transmitting the clear-to-send frame within the short interframe space time interval or the point coordination function interframe space time interval after wirelessly receiving the return transmission opportunity frame; and
a third-party access point, based on overhearing the clear-to-send frame, defers a wireless transmission until after the transmission opportunity thereby avoiding a collision with the sharing AP during the remaining portion of the transmission opportunity returned to the sharing AP.

6. The method of claim 1, wherein:
the return transmission opportunity frame comprises a particular field for prompting the sharing access point to wirelessly transmit a clear-to-send frame within a short interframe space time interval or a point coordination function interframe space time interval after wirelessly receiving the return transmission opportunity frame;
the method further comprises: in response to the sharing access point wirelessly receiving the return transmission opportunity frame with the particular field, the sharing access point generating the clear-to-send frame, and the sharing access point wirelessly transmitting the clear-to-send frame within the short interframe space time interval or the point coordination function interframe space time interval after wirelessly receiving the return transmission opportunity frame; and
a third-party access point, based on overhearing the return transmission opportunity frame, attempts a channel access during the remaining portion of the transmission opportunity returned to the sharing AP.

7. The method of claim 1, wherein the return transmission opportunity frame is a contention free end (CF-End) frame.

8. The method of claim 7, wherein a transmitter address field of the contention free end (CF-End) frame indicates an address of the shared access point.

9. The method of claim 7, wherein a transmitter field of the contention free end (CF-End) frame comprises a basic service set identifier of the shared access point, a group basic service set identifier shared between the sharing access point and shared access point, or an access point identifier of the shared access point.

10. The method of claim 7, further comprising:
the sharing access point wirelessly transmitting a physical layer protocol data unit (PPDDU) within a short interface space (SIFS) time interval or a point coordination function interframe space (PIFS) time interval after wirelessly receiving the contention free end (CF-End) frame.

11. The method of claim 7, wherein a duration field of the contention free end (CF-End) frame indicates the portion of the transmission opportunity remaining.

12. The method of claim 7, wherein a third-party access point, based on overhearing the contention free end (CF-End) frame, resets a network allocation vector counter.

13. The method of claim 7, wherein a third-party access point, based on overhearing the contention free end (CF-End) frame, attempts a channel access during the remaining portion of the transmission opportunity returned to the sharing access point.

14. The method of claim 1, further comprising:
resuming, during the remaining portion of the transmission opportunity returned to the sharing access point, wireless transmission of data buffered at the sharing access point.

15. The method of claim 1, further comprising:
facilitating allocation of a portion of the remaining portion of the transmission opportunity to an alternative access point.

16. A method performed by a wireless device operating as a shared access point in a first basic service set, the method comprising:
receiving a control frame wirelessly transmitted by a sharing access point in a second basic service set that overlaps the first basic service set, the control frame wirelessly transmitted by the sharing access point to facilitate allocation of a transmission opportunity held by the sharing access point to the shared access point;
(a) wirelessly transmitting a physical layer protocol data unit (PPDU) during the transmission opportunity, or (b) soliciting a wireless transmission of a physical layer protocol data unit (PPDU) from a station in the first basic service set during the transmission opportunity;
generating a return transmission opportunity frame to facilitate return of a remaining portion of the transmission opportunity to the sharing access point; and
wirelessly transmitting the return transmission opportunity frame to return the remaining portion of the transmission opportunity to the sharing access point.

17. The method of claim 16, further comprising:
wirelessly transmitting a physical layer protocol data unit (PPDU) during the transmission opportunity.

18. The method of claim 16, further comprising:
soliciting a wireless transmission of a physical layer protocol data unit (PPDU) from a station in the first basic service set during the transmission opportunity.

19. A wireless device capable of functioning as a sharing access point in a first basic service, the wireless device comprising:
a radio frequency transceiver;
a memory device;
a set of one or more processors coupled to the memory device; and
a set of instructions stored in the memory and configured to cause the sharing access point to perform:
generating a control frame to facilitate allocation of a transmission opportunity held by the sharing access point to a shared access point, the shared access point in a second basic service set that overlaps the first basic service set;
wirelessly transmitting the control frame to facilitate allocation of the transmission opportunity held by the sharing access point to the shared access point;
wirelessly receiving a return transmission opportunity frame, wirelessly transmitted by the shared access point, facilitating return of a remaining portion of the transmission opportunity to the sharing access point; and
(b) resuming, during the remaining portion of the transmission opportunity returned to the sharing access point, wireless transmission of data buffered at the sharing access point, or (b) facilitating allocation of a portion of the remaining portion of the transmission opportunity to an alternative access point.

20. The wireless device of claim 19, further comprising:
a set of instructions stored in the memory and configured to cause the sharing access point to perform:
resuming, during the remaining portion of the transmission opportunity returned to the sharing access point, wireless transmission of data buffered at the sharing access point.

21. The wireless device of claim 19, further comprising:
a set of instructions stored in the memory and configured to cause the sharing access point to perform:
facilitating allocation of a portion of the remaining portion of the transmission opportunity to an alternative access point.

22. A wireless device capable of functioning as a shared access point in a first basic service, the wireless device comprising:
a radio frequency transceiver;
a memory device;
a set of one or more processors coupled to the memory device; and
a set of instructions stored in the memory and configured to cause the shared access point to perform:
receiving a control frame wirelessly transmitted by a sharing access point in a second basic service set that overlaps the first basic service set, the control frame wirelessly transmitted by the sharing access point to facilitate allocation of a transmission opportunity held by the sharing access point to the shared access point;
(a) wirelessly transmitting a physical layer protocol data unit (PPDU) during the transmission opportunity, or (b) soliciting a wireless transmission of a physical layer protocol data unit (PPDU) from a station in the first basic service set during the transmission opportunity;
generating a return transmission opportunity frame to facilitate return of a remaining portion of the transmission opportunity to the sharing access point; and
wirelessly transmitting the return transmission opportunity frame to return the remaining portion of the transmission opportunity to the sharing access point.

23. The wireless device of claim 22, further comprising:
a set of instructions stored in the memory device and configured to cause the shared access point to perform:
wirelessly transmitting a physical layer protocol data unit (PPDU) during the transmission opportunity.

24. The wireless device of claim 22, further comprising:
a set of instructions stored in the memory device and configured to cause the shared access point to perform:
soliciting a wireless transmission of a physical layer protocol data unit (PPDU) from a station in the first basic service set during the transmission opportunity.
